(19) United States
(12) Patent Application Publication
(10) Pub. No.: US 2012/0086644 A1
(43) Pub. Date: Apr. 12, 2012

(54) KEYBOARD

(75) Inventors: CHUNG-CHI HUANG, Tu-Cheng (TW); HAI-QING ZHOU, Shenzhen (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/914,952

(22) Filed: Oct. 28, 2010

(30) Foreign Application Priority Data
Oct. 12, 2010 (CN) 201010504184.7

(51) Int. Cl. G06F 3/02

(52) U.S. Cl. 345/168

(57) ABSTRACT

A keyboard includes a mainbody, a number of keys, an interface, a control circuit, a switch, and a light emitting diode (LED). The interface includes a first group of pins and a second group of pins. The first and second groups of pins are connected to a motherboard. One of the second group of pins receives a +5V_standby voltage or a +3.3V_standby voltage from the motherboard. The control circuit is set inside the mainbody and is connected to the keys and the first group of pins of the interface. One of the second group of pins of the interface is further connected to an anode of the LED through the switch, and a cathode of the LED is grounded.

### BACKGROUND

1. Technical Field

The present disclosure relates to a keyboard.

2. Description of Related Art

Keyboards are used in a variety of applications for entry of alphanumeric and other types of data into a computer system. However, it is hard to use a keyboard in a dark or gloomy environment. In addition, conventional light-emitting keyboards cannot light when computer systems are not powered on, which is inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a schematic, isometric view of an exemplary embodiment of a keyboard, the keyboard includes an interface.

FIG. 2 is a block diagram of the keyboard of FIG. 1.

FIG. 3 is a schematic plan view of the interface of FIG. 1.

FIG. 4 is a schematic view of the interface of FIG. 3 connected to a motherboard.

### DETAILED DESCRIPTION

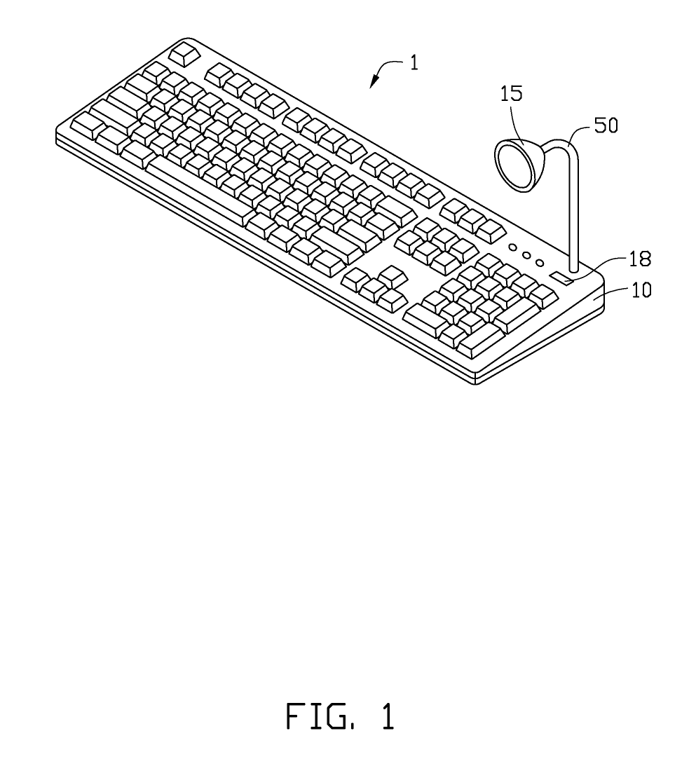

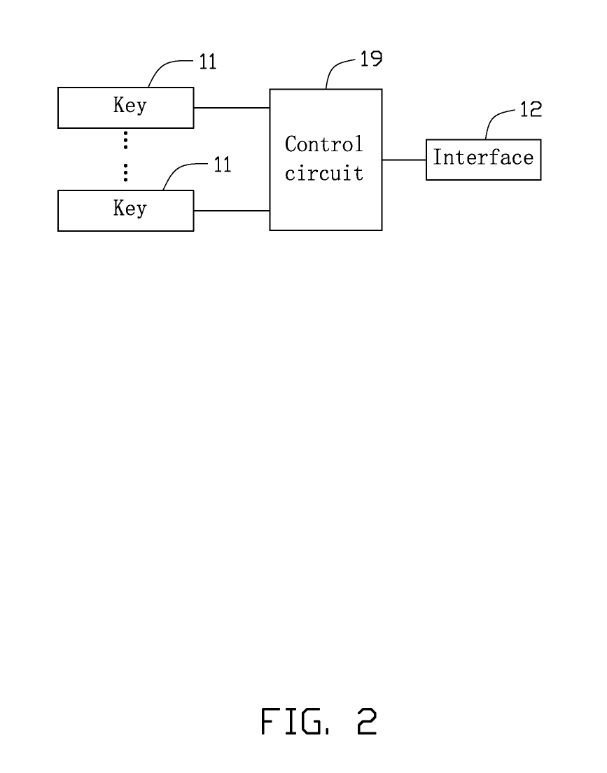

Referring to FIGS. 1, 2, and 4, an exemplary embodiment of a keyboard 1 includes a mainbody 10, an interface 12, a light emitting diode (LED) 15, a resistor R1, and a switch 18. A control circuit 19 is set inside the mainbody 10. A number of key 11 are set on the mainbody 10 and connected to the control circuit 19.

The LED 15 is connected to a first end of a pole 50. A second end of the pole 50 opposite to the first end is mounted to a top of the mainbody 10. The switch 18 is set on the top of the mainbody 10, to control the LED 15. In other embodiments, the switch 18 can be set at other locations, such as a side of the mainbody 10.

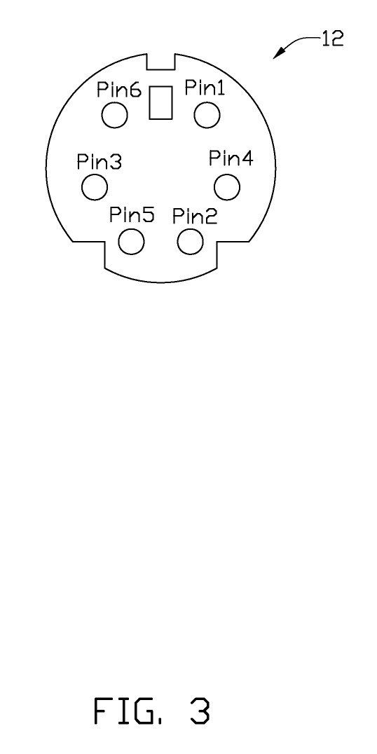

Referring to FIG. 3, the interface 12 is a personal system 2 (PS/2) interface. The interface 12 includes a clock pin Pin1, a data pin Pin2, a power pin Pin3, a ground pin Pin4, and two idle pins Pin5 and Pin6.

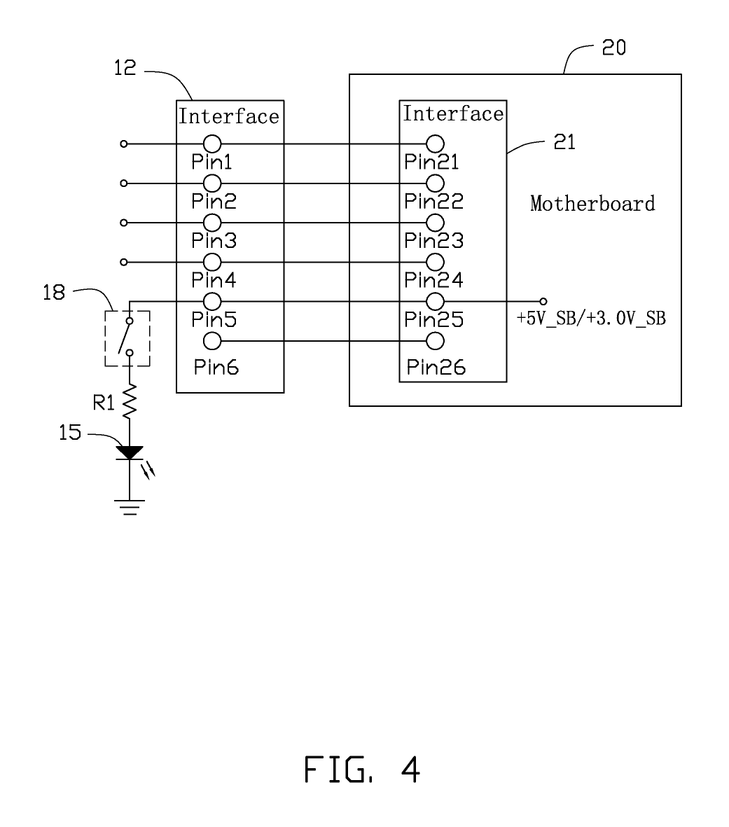

Referring to FIG. 4, the clock pin Pin1, the data pin Pin2, the power pin Pin3, and the ground pin Pin4 are all connected to the control circuit 19. The idle pin Pin5 is connected to an anode of the LED 15 through the switch 18 and the resistor R1 in series. A cathode of the LED 15 is grounded.

In use, the interface 12 of the keyboard 1 is connected to an interface 21 of a motherboard 20. The interface 21 is a PS/2 interface. The interface 21 includes a clock pin

Pin21, a data pin Pin22, a power pin Pin23, a ground pin Pin24, and two idle pins Pin25 and Pin26. The clock pin Pin1, the data pin Pin2, the power pin Pin3, the ground pin Pin4, and the idle pins Pin 5 and Pin 6 of the interface 12 are respectively connected to the clock pin Pin21, the data pin Pin22, the power pin Pin23, the ground pin Pin24, and the idle pins Pin25 and Pin26, for transmitting signals between the keyboard 1 and the motherboard 20. The idle pin Pin25 receives a +5V_standby (+5V_SB) voltage of the motherboard 20. In other embodiments, the idle pin P25 may receive a +3.3V_standby (+3.3V_SB) voltage of the motherboard 20.

When the switch 18 is turned on, the LED 15 is powered on bathing the keyboard 1 and immediate surroundings in light. Because the motherboard 20 provides the +5V_SB voltage even when the computer system is not on, the LED 15 can be used anytime.

In other embodiments, the anode of the LED 15 may be connected to the idle pin Pin6 through the switch 18 and the resistor R1 in series. In another embodiment, the idle pins Pin5 and Pin6 are respectively connected to anodes of two LEDs through a switch and a resistor in series, in which case, two switches control the two LEDs to light up the keyboard 1. It should also be apparent that the LED 15 may be replaced by a number of LEDs connected in series.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A keyboard comprising:
a mainbody;
a plurality of keys;
an interface comprising a first group of pins and a second group of pins, wherein the first and second groups of pins are configured to be connected to a motherboard, one of the second group of pins receives a +3.3V_standby voltage from the motherboard;
a control circuit set inside the mainbody, and connected to the plurality of keys and the first group of pins of the interface;
a switch; and
a light emitting diode (LED), wherein one of the second group of pins of the interface is further connected to an anode of the LED through the switch, a cathode of the LED is grounded.

2. The keyboard of claim 1, wherein the switch is mounted on a top of the mainbody.

3. The keyboard of claim 1, wherein the interface is a personal system 2 interface, the first group of pins of the interface comprise a clock pin, a data pin, a power pin, and a ground pin, the second group of pins of the interface comprise two idle pins.

4. The keyboard of claim 1, wherein the LED is connected to a first end of a pole, a second end of the pole opposite to the first end is mounted to a top of the mainbody.

5. The keyboard of claim 1, wherein a resistor is connected between the anode of the LED and the switch.

6. A keyboard comprising:
a mainbody;
a plurality of keys;
an interface comprising a first group of pins and a second group of pins, wherein the first and second groups of pins are operable to be connected to a motherboard, one of the second group of pins receives a +5V_standby voltage from the motherboard;
a control circuit set inside the mainbody, and connected to the plurality of keys and the first group of pins of the interface;
a switch; and
a light emitting diode (LED), wherein one of the second group of pins of the interface is further connected to an anode of the LED through the switch, a cathode of the LED is grounded.

7. The keyboard of claim 6, wherein the switch is mounted on a top of the mainbody.

8. The keyboard of claim 6, wherein the interface is a personal system 2 interface, the first group of pins of the interface comprise a clock pin, a data pin, a power pin, and a ground pin, the second group of pins of the interface comprise two idle pins.

9. The keyboard of claim 6, wherein the LED is connected to a first end of a pole, a second end of the pole opposite to the first end is mounted to a top of the mainbody.

10. The keyboard of claim 6, wherein a resistor is connected between the anode of the LED and the switch.
